(19) United States
(12) Patent Application Publication
(10) Pub. No.: US 2004/0181026 A1
(43) Pub. Date: Sep. 16, 2004

(54) Rosin modified phenolic resin, gel varnish using the same, printing ink, printing method, and method for producing rosin modified phenolic resin

(75) Inventors: Hiroshi Toyoda, Koshigaya-shi (JP); Tadahisa Chiyoda, Soka-shi (JP)

Correspondence Address: SUGHRUE MION, PLLC, 2100 PENNSYLVANIA AVENUE, N.W., SUITE 800, WASHINGTON, DC, 20037, US

(73) Assignee: HARIMA CHEMICALS, INC.

(21) Appl. No.: 10/795,235

(22) Filed: Mar. 9, 2004

(30) Foreign Application Priority Data
Mar. 10, 2003 (JP) 2003-63977

(51) Int. Cl. C08G 8/04

(52) U.S. Cl. 528/129; 530/215

(57) ABSTRACT

The present invention provides a rosin modified phenolic resin having a weight average molecular weight of 3,000 to 400,000, which is obtained by reacting a monoester with a polyhydric alcohol and a phenol formaldehyde initial condensate, said monoester being prepared by partially esterifying a rosin and an animal and vegetable oil fatty acid with a monoalcohol, and a method for producing the same. Also the present invention provides a gel varnish comprising the resin, an animal and vegetable oil component, and a gelling agent, and a printing ink comprising the gel varnish. Printing is conducted using the printing ink.

Priority is claimed to Japanese Patent Applications No. 2003-63977 filed on Mar. 10, 2003, the disclosure of which is incorporated by reference in its entirety.

### BACKGROUND OF THE INVENTION

1. Field of the Invention

The present invention relates to a rosin modified phenolic resin, a gel varnish using the same, a printing ink, a printing method, and a method for producing a rosin modified phenolic resin and, more particularly, to a rosin modified phenolic resin for offset printing ink, which is environmentally friendly because it contains no or a reduced amount of a volatile organic solvent, and also has excellent printability and excellent economical efficiency, a gel varnish using the same, a printing ink, a printing method, and a method for producing a rosin modified phenolic resin.

2. Description of Related Art

With the increase of understanding of environmental problems in offset printing, a trial of reducing toxicity of raw materials used at present or replacing the raw materials by raw material with less toxicity has recently been made. For example, an aromatic component has been removed from volatile organic solvents such as mineral oil, which have conventionally been used as raw materials, and also there has been developed a non-VOC (Volatile Organic Compound) or VOC-less offset printing ink wherein a volatile organic solvent is replaced by an animal and vegetable oil or a fatty acid monoester originating from the animal and vegetable oil. However, only by replacing the volatile organic solvent by the fatty acid monoester originating from the animal and vegetable oil, drying properties of the ink drastically deteriorate, and thus causing problems such as deposition of the ink on the back surface of a paper and blocking upon stacking of printed matters.

With the increase of the speed of a printing press for the purpose of improving productivity of printed matters, inks suited for high speed printing have recently been developed. In such a high speed printing technique, non-VOC or VOC-less offset printing inks, wherein a volatile organic solvent is replaced by an animal and vegetable oil or a fatty acid monoester originating from the animal and vegetable oil, are effective for wood free papers and newspapers which have porosity and are easy to penetrate. However, good balance between gloss and drying properties can not be obtained for coat papers and art papers as main matters to be printed, and desired printing quality can not be obtained. It is impossible to satisfy printing quality required by the market if the volatile organic solvent is not used in combination in case of these printing papers.

As shown in the following patent publications, there have been made various trials of using an animal and vegetable oil or fatty acid monoester originating from the animal and vegetable oil in an offset printing ink in place of the volatile organic solvent.

Japanese Unexamined Patent Publication No. 5-112745 discloses a trial of using a fatty acid monoester comprising a fatty acid having 5 to 21 carbon atoms and a monoalcohol having 1 to 4 carbon atoms as a solvent for lithographic ink or letterpress ink.

Japanese Unexamined Patent Publication No. 6-93220 discloses a printing ink containing an aliphatic compound having 18 to 50 carbon atoms having one or more unsaturated groups, such as unsaturated fatty acid ester in a resin varnish.

Japanese Unexamined Patent Publication No. 2001-288394 discloses a printing ink composition having a volatile organic solvent content of 3% by weight or less, comprising a rosin modified phenolic resin having a weight average molecular weight of 30,000 or more, and a vegetable oil and/or a vegetable oil fatty acid ester which dissolve the resin.

Japanese Unexamined Patent Publication No. 2002-69354 discloses a printing ink composition having a volatile organic solvent content of 3% by weight or less, comprising a rosin modified phenolic resin having a weight average molecular weight of less than 30,000, and a vegetable oil fatty acid ester which dissolves the resin.

Japanese Unexamined Patent Publication No. 2002-265839 discloses an ink for web offset printing press, which has a petroleum-based mineral oil content of 25% or less, comprising a rosin ester resin modified with a monobasic acid, a dibasic acid or a tribasic acid, and a fatty acid ester.

Japanese Unexamined Patent Publication No. 2002-3770 discloses a gel varnish for offset printing ink, which is obtained by heating a mixture of 20 to 60% of a rosin modified phenolic resin and/or a rosin modified maleinated resin, a vegetable oil component, optional mineral oil and optional gelling agent, and 0.5 to 15% by weight of an olefinic or dienic polymer.

Japanese Unexamined Patent Publication No. 2002-338868 discloses an offset sheet fed printing ink obtained by dissolving a rosin modified phenolic resin having a weight average molecular weight of 20,000 to 150,000 in a soybean oil fatty acid ester while heating, and adding a drying agent containing a calcium salt of unsaturated fatty acid and a printability-imparting agent such as styrene resin, acrylic resin and benzoguanamine resin each having a particle size of 0.5 to 1.5 μm.

However, printing inks (non-VOC offset printing inks, or VOC-less offset printing inks containing a prescribed amount of a volatile mineral oil) disclosed in the above respective publications cause drastic deterioration of ink drying properties, especially for coat papers and art papers, due to its poor permeability of the solvent into the paper or vaporization of the solvent, as compared with conventional offset printing inks, and thus problems such as long setting time, deposition on the back surface of the paper and blocking have not been solved. In case of the above printing inks, there arise problems that misting is likely to occur and emulsifiability resistance is poor.

As disclosed in the following patent publications, oil-modified rosin phenol resins containing oils such as soybean oil as raw materials are known as resins for offset printing ink.

Japanese Unexamined Patent Publication No. Sho 57-2319 discloses an oil-modified rosin phenol resin obtained by reacting a resol type phenols formaldehyde initial condensate, a vegetable oil having an iodine value of 100 or more, a rosin, and a polyhydric alcohol.

Japanese Unexamined Patent Publication No. Sho 57-61017 discloses an oil-modified rosin phenol resin obtained by reacting phenols, formaldehyde, an animal and vegetable oil having an iodine value of 100 or more, a rosin, and a monohydric alcohol and/or a polyhydric alcohol.

These oil-modified rosin phenol resins were designed on the assumption that a volatile mineral oil is used. Therefore, when using an animal and vegetable oil or a fatty acid monoester originating from the animal and vegetable oil in place of the volatile mineral oil, viscosity required to printing can not be obtained, and thus drying properties and emulsifiability resistance drastically deteriorate.

### SUMMARY OF THE INVENTION

A main advantage of the present invention is to provide a rosin modified phenolic resin which is environmentally friendly because it contains no or a reduced amount of a volatile organic solvent, and also has excellent printability, a gel varnish using the same, printing ink, a printing method, and a method for producing a rosin modified phenolic resin.

Another advantage of the present invention is to provide a rosin modified phenolic resin which contains an animal and vegetable oil component as the solvent, and also gives a non-VOC or VOC-less printing ink excellent in gloss, drying properties, emulsifiability resistance and misting resistance when printed on coat papers and art papers, a gel varnish using the same, a printing ink, a printing method, and a method for producing a rosin modified phenolic resin.

Still another advantage of the present invention is to provide a printing ink having excellent economical efficiency.

The rosin modified phenolic resin of the present invention is a rosin modified phenolic resin having a weight average molecular weight of 3,000 to 400,000, which is obtained by reacting a monoester with a polyhydric alcohol and a phenol formaldehyde initial condensate, said monoester being prepared by partially esterifying a rosin and an animal and vegetable oil fatty acid with a monoalcohol.

In the present invention, it is important that a portion of the rosin and the animal and vegetable oil fatty acid is esterified with the monoalcohol before reacting the rosin and the animal and vegetable oil fatty acid with the polyhydric alcohol and the phenol formaldehyde initial condensate. It is assumed that, by passing through a monoester having a partially monoesterified structure, excess construction of a three-dimensional structure caused by excess esterification with the polyhydric alcohol is suppressed and a resin having a proper three-dimensional structure and a proper molecular weight range can be obtained. The resin thus obtained has proper solubility in the animal and vegetable oil component such as fatty acid monoester. Consequently, even in case of printing on coat papers and art papers, the animal and vegetable oil component can be used as the solvent in place of the volatile organic solvent and, moreover, a resin excellent in drying properties, gloss, emulsifiability resistance and misting resistance can be obtained.

The gel varnish of the present invention comprises the rosin modified phenolic resin, an animal and vegetable oil component, and a gelling agent. Therefore, when using the gel varnish of the present invention, it is made possible to use no volatile organic solvent or to reduce the amount of the volatile organic solvent. In the gel varnish of the present invention, a portion or all of the animal and vegetable oil component may be a fatty acid monoester.

The printing ink of the present invention comprises the gel varnish. The printing ink preferably contains 60 to 90% by weight of the gel varnish.

The printing method of the present invention comprises printing such as offset printing using the printing ink.

The rosin modified phenolic resin can be produced in the following manner. A first method of the present invention comprises esterifying a rosin and an animal and vegetable oil fatty acid with a monoalcohol, esterifying the product with a polyhydric alcohol, and reacting the product with a phenol formaldehyde initial condensate, thereby to produce a rosin modified phenolic resin having a weight average molecular weight of 3,000 to 400,000.

A second method of the present invention comprises esterifying a rosin and an animal and vegetable oil fatty acid with a monoalcohol, reacting the product with a phenol formaldehyde initial condensate, and esterifying the product with a polyhydric alcohol, thereby to produce a rosin modified phenolic resin having a weight average molecular weight of 3,000 to 400,000.

As described above, in the present invention, it is important that a portion of the rosin and the animal and vegetable oil fatty acid is esterified with the monoalcohol before reacting the rosin and animal and vegetable oil fatty acid with the polyhydric alcohol and the phenol formaldehyde initial condensate.

The printing ink obtained by the present invention can be used not only as an offset printing ink, but also as inks for screen printing and letterpress printing because of less content of the decomposition product and the nonuniform gelling component in the rosin modified phenolic resin.

The objects and advantages of the present invention will become apparent from the following detailed description.

### DESCRIPTION OF PREFERRED EMBODIMENTS

<Rosin Modified Phenolic Resin>

One embodiment of the present invention will be described in detail. The resin of the present invention is a resol type rosin modified phenolic resin obtained by reacting a monoester with a polyhydric alcohol and a phenol formaldehyde initial condensate, said monoester being prepared by partially esterifying a rosin and an animal and vegetable oil fatty acid with a monoalcohol.

Examples of the rosin include gum rosin, wood rosin, tall oil rosin, distilled rosin, polymerized rosin, disproportionated rosin, and hydrogenated rosin. The disproportionated rosin and hydrogenated rosin can not be used because they do not react with the phenol formaldehyde initial condensate, but can be used in combination with the other rosin.

Examples of the animal and vegetable oil fatty acid include caproic acid, caprylic acid, capric acid, isooctanoic acid, isononanoic acid, lauric acid, myristic acid, palmitic acid, palmitoleic acid, stearic acid, isostearic acid, oleic acid, linoleic acid, linolenic acid, eleostearic acid, arachdic acid, arachidonic acid, behenic acid, and erucic acid, each including an alkyl residue excluding a carboxyl group having 5 to 21 carbon atoms. These animal and vegetable oil fatty acids are originated from animal and vegetable oils such as coconut oil, palm oil, rapeseed oil, soybean oil, hydrogenated soybean oil, linseed oil, tung oil, beef tallow, and fish oil.

These animal and vegetable oil fatty acids can be used alone, and preferably used in the form of a mixture such as coconut oil fatty acid, palm oil fatty acid, rapeseed oil fatty acid, or soybean oil fatty acid in view of economy. Also tall oil fatty acid and monomer acid can be preferably used. The monomer acid is by-product obtained when a polymerized fatty acid is produced by polymerizing an unsaturated fatty acid such as tall oil fatty acid, and contains a fatty acid having a branched structure, in addition to stearic acid, oleic acid or the like.

The tall oil can be used as a supply source of the rosin and the animal and vegetable oil fatty acid. In the step of purifying the tall oil, a mixing ratio of the rosin to the vegetable oil fatty acid can be optionally adjusted.

Examples of the monoalcohol include alcohols whose alkyl group has 1 to 8 carbon atoms, for example, methanol, ethanol, propanol, isopropanol, butanol, isobutanol, amyl alcohol, isoamyl alcohol, hexyl alcohol, heptyl alcohol, octyl alcohol, and 2-ethylhexyl alcohol.

Examples of the polyhydric alcohol include glycerin, trimethylolethane, trimethylolpropane, diethylene glycol, triethylene glycol, 1,6-hexanediol, pentaerythritol, dipentaerythritol, and sorbitol.

As described above, in the rosin modified phenolic resin of the present invention, a portion of the rosin and the animal and vegetable oil fatty acid is esterified with the monoalcohol before reacting with the polyhydric alcohol and the phenol formaldehyde initial condensate.

The first method of producing the rosin modified phenolic resin comprises esterifying a rosin and an animal and vegetable oil fatty acid with a monoalcohol, esterifying the product with a polyhydric alcohol, and reacting the product with a phenol formaldehyde initial condensate.

The second method of producing the rosin modified phenolic resin comprises esterifying a rosin and an animal and vegetable oil fatty acid with a monoalcohol, reacting the product with a phenol formaldehyde initial condensate, and esterifying the product with a polyhydric alcohol.

To partially esterify with the monoalcohol, for example, a rosin, an animal and vegetable oil fatty acid and a monoalcohol is charged in a rector and a catalyst is optionally added, and then they are reacted under reflux of the monoalcohol.

The amount of the animal and vegetable oil fatty acid is preferably from 2 to 300 parts by weight, and more preferably from 10 to 120 parts by weight, based on 100 parts by weight of the rosin.

The monoalcohol is preferably added in the amount within a range from 0.05 to 1.5, and more preferably form 0.3 to 0.9, in terms of an OH equivalent based on carboxylic acid of the rosin and the animal and vegetable oil fatty acid. The temperature required for esterification with the monoalcohol is preferably 60° C. or higher, and more preferably from 100 to 260° C. The reaction time required for esterification with the monoalcohol is preferably from 1 to 14 hours, and more preferably from 2 to 8 hours.

The monoester thus obtained preferably has an acid value within a range from 30 to 170. By adjusting the acid value of the monoester within the above range, more preferable reaction ratio of the monoalcohol and the polyhydric alcohol to the rosin and the animal and vegetable oil fatty acid is achieved, and thus excellent printability can be obtained. Hereupon, acid value is defined as the number of milligrams of potassium hydroxide (KOH) required to neutralize the alkali-reactive groups in one gram of material.

In the present invention, before esterification with the monoalcohol, the rosin and the animal and vegetable oil fatty acid may be modified by adding an α,β-ethylenically unsaturated dibasic acid and heating at 160 to 240° C. Consequently, it is made possible to more improve drying properties of the printing ink. The α,β-ethylenically unsaturated dibasic acid may be an anhydride. Examples of the α,β-ethylenically unsaturated dibasic acid include fumaric acid, maleic acid, maleic anhydride. When producing rosin ester, it is also possible to simultaneously use another dibasic acids such as adipic acid, sebacic acid, azelaic acid, itaconic acid, itaconic anhydride, phthalic anhydride, isophthalic acid, terephthalic acid, trimellitic anhydride, pyromellitic acid, dimer acid, and trimer acid.

The esterification with the monoalcohol may be conducted in the absence of a catalyst when the reaction temperature is 100° C. or higher. To increase the reaction rate, an acid catalyst may be used. As the acid catalyst, there can be used organic sulfonic acids such as p-toluenesulfonic acid, methanesulfonic acid, ethanesulfonic acid, and dodecylbenzenesulfonic acid; and mineral acids such as sulfuric acid and hydrochloric acid.

The rosin modified phenolic resin of the present invention can be obtained by adding a polyhydric alcohol in the reactor where the monoester was obtained as described above, thereby to further perform the esterification, and adding a phenol formaldehyde initial condensate, thereby to react with the phenol formaldehyde initial condensate, or previously adding the phenol formaldehyde initial condensate, thereby to react with the phenol formaldehyde initial condensate, and adding the polyhydric alcohol, thereby to perform the esterification.

The polyhydric alcohol is preferably added in the amount within a range from 0.5 to 1.5, and more preferably from 0.9 to 1.2, in terms of an OH equivalent based on the remaining carboxylic acid. The amount of the polyhydric alcohol to be added has a close relation with weight average molecular weight, viscosity and solubility in solvent of the resulting resin as well as emulsifiability after forming into an ink. When the amount of the polyhydric alcohol is more than the above range, desired performances may not be obtained. On the other hand, when the amount is less than the above range, the reaction may require a long time because the reaction rate decreases. The temperature required for esterification with the polyhydric alcohol is preferably from 200 to 280° C., and more preferably 240 to 280° C. The reaction time required for esterification with the polyhydric alcohol is preferably from 2 to 12 hours, and more preferably from 4 to 8 hours.

The amount of the phenol formaldehyde initial condensate to be added is preferably from 10 to 150 parts by weight, and more preferably from 20 to 100 parts by weight, based on 100 parts by weight in total amount of the rosin and the animal and vegetable oil fatty acid. The temperature required for reaction with the condensate is preferably from 100 to 280° C., and more preferably 140 to 280° C. The reaction time required for reaction with the condensate is preferably from 2 to 12 hours, and more preferably from 4 to 8 hours.

Furthermore, the rosin modified phenolic resin of the present invention may be modified with a petroleum resin. Modification with the petroleum resin is conducted in the following manner. In the first method, after esterifying with the polyhydric alcohol, the petroleum resin is added before reacting with the phenol formaldehyde initial condensate, and then the product obtained by esterifying with the polyhydric alcohol is modified with the petroleum resin by heating at 100 to 280° C. In the second method, before reacting with the phenol formaldehyde initial condensate, the petroleum resin is added to the monoester and the monoester is modified with the petroleum resin by heating at 100 to 280° C. When using the rosin modified phenolic resin modified with the petroleum resin as the printing ink, hydrophobicity of the printing ink is improved and emulsifiability resistance is improved.

As the petroleum resin, those having an unsaturated bond in the molecule, for example, petroleum resins classified into the followings based on a structure having a carbon-carbon double bond can be used. That is, the petroleum resin can be classified into indene, coumarone, cyclopentadiene and dicyclopentadiene resins each having an unsaturated cyclic structure; pentene and pentadiene resins each having an unsaturated hydrocarbon chain; and vinyltoluene and α-methylstyrene resins each having a carbon-carbon double bond and an unsaturated hydrocarbon chain substitiuted with a conjugated aromatic ring.

The phenol formaldehyde initial condensate can be obtained by adding a volatile organic solvent (for example, xylene) to a phenol component and a formaldehyde component in the amount within a range from 5 to 100 parts by weight, and preferably 10 to 50 parts by weight, based on 100 parts by weight in the total amount of these components, and performing the condensation reaction in the presence of an alkali catalyst. The phenol formaldehyde initial condensate is a resol type phenol resin and is combined with the rosin modified with the monoalcohol and the polyhydric alcohol to form a chroman ring.

As the alkali catalyst, there can be used potassium hydroxide, sodium hydroxide, calcium hydroxide, magnesium hydroxide, amines, and aqueous ammonia solution.

As the phenol component, there can be used any aromatic compounds having a phenolic hydroxyl group, for example, phenol, p-cresol, p-tertiary butylphenol, p-amylphenol, p-octylphenol, p-nonylphenol, p-dodecylphenol, and bisphenol A. Among these compounds, bisphenols and phenol, and alkylphenol compounds substituted with an alkyl group having 4 or less carbon atoms at the para-position are preferable. As the formaldehyde component, paraformaldehyde and formalin can be used.

The rosin modified phenolic resin thus obtained preferably has a weight average molecular weight within a range from 3,000 to 400,000, and more preferably from 5,000 to 300,000. When the weight average molecular weight is less than 3,000, drying properties and misting resistance may deteriorate. On the other hand, when the weight average molecular weight exceeds 400,000, gloss may deteriorate. To adjust the weight average molecular weight within the above range, there can be used conventionally known methods such as modification of the constituent components of the resin, modification of the composition ratio, and modification of production conditions.

<Gel Varnish>

The rosin modified phenolic resin of the present invention is obtained in the form of a solid or a viscous liquid according to the kind and amount of raw materials as well as production conditions. A gel varnish for offset printing ink having desired physical properties can be obtained by adding an animal and vegetable oil component and a gelling agent to the rosin modified phenolic resin and gelling the rosin modified phenolic resin. Examples of the gelling agent include aluminum compounds such as aluminum chelete and aluminum soaps.

Without isolating the rosin modified phenolic resin, the reaction product obtained in the production of the rosin modified phenolic resin can be used in the production of the gel varnish. For example, the gel varnish can be obtained by adding the reaction product obtained above to a solution, which is previously prepared by adding an animal and vegetable oil component and a gelling agent and uniformly mixing them, performing the gelling reaction at 120 to 220° C., and adjusting the viscosity. As described above, by continuously performing from the production of the rosin modified phenolic resin to the preparation of the gel varnish, it becomes unnecessary to perform solidification so as to isolate the resin and redissolution, and thus wastes and environmental burden can be reduced and energy required for the production can be remarkably saved.

A portion or all of the animal and vegetable oil component is preferably a fatty acid monoester. Examples of the fatty acid monoester include methyl laurate, butyl laurate, methyl myristate, butyl myristate, methyl palmitate, butyl palmitate, methyl stearate, butyl stearate, octyl stearate, methyl oleate, butyl oleate, octyl oleate, butyl linoleate, and octyl linoleate, and mixtures thereof. Furthermore, these fatty acids or mixtures thereof may be esterified with alcohols such as methyl alcohol, butyl alcohol, and octyl alcohol. As the animal and vegetable oil component, for example, there can be used animal and vegetable oils such as cotton seed oil, soybean oil, safflower oil, dehydrated castor oil, linseed oil, tung oil, cuttlefish oil, and sardine oil. These animal and vegetable oils may be added, together with the fatty acid monoester. Together with the animal and vegetable oil component, a small amount of volatile ink solvents such as “Solvent AF6, manufactured by New Nippon Petroleum Processing Co., Ltd.” and “Solvent AF7, manufactured by New Nippon Petroleum Processing Co., Ltd.” may be added.

The gel varnish of the present invention contains 35 to 70% by weight, preferably 40 to 60% by weight of the rosin modified phenolic resin. In case of using for web offset ink, the content of the animal and vegetable oil is about 5 to 8% by weight of the gel varnish. In case of using for sheet-fed ink, the content is preferably about 15 to 20% by weight of the gel varnish. The remaining components of the gel varnish are composed of the fatty acid monoester and gelling agent required for adjusting viscosity and elasticity of the printing ink.

<Printing Ink>

Offset printing inks such as sheet-fed ink and web offset ink can be obtained by dispersing yellow, crimson, indigo blue and jet-black pigments in the gel varnish obtained above, optionally adding compounds such as wear resistance modifiers, ink dryers, drying inhibitors, and adjusting the viscosity to proper viscosity. The content of the gel varnish in the printing ink is preferably from about 60 to 90% by weight. In case of adjusting viscosity and elasticity of the printing ink, volatile ink solvents such as “Solvent AF6, manufactured by New Nippon Petroleum Processing Co., Ltd.” and “Solvent AF7, manufactured by New Nippon Petroleum Processing Co., Ltd.” may be added in the proportion of 3% or less.

The printing ink of the present invention can also be used as news ink and letterpress ink. Furthermore, it can also be used as gravure ink and flexographic ink by dissolving the resin of the present invention in an aliphatic or alicyclic solvent having a boiling point of 140° C. or lower at normal pressure.

As described above, according to the rosin modified phenolic resin of the present invention, even if the animal and vegetable oil component is used as the solvent in place of the volatile organic solvent, a resin having excellent printability such as drying properties, gloss, emulsifiability resistance, misting resistance or the like can be obtained.

In the present invention, tall oil is preferably used as the mixture of a rosin and an animal and vegetable oil fatty acid. The tall oil contains a rosin and a vegetable oil fatty acid (for example, oleic acid, linoleic acid or the like). In the step of purifying the tall oil, a mixing ratio of the rosin to the vegetable oil fatty acid can be optionally adjusted. Therefore, when using the tall oil in the production of the rosin modified phenolic resin, the rosin and the animal and vegetable oil fatty acid can be supplied at a time, thereby making it possible to improve workability and to reduce cost, resulting in excellent economical efficiency.

When the acid value of the monoester in the present invention is from 30 to 170, more preferable reaction ratio of the monoalcohol and the polyhydric alcohol to the rosin and the animal and vegetable oil fatty acid is achieved, and thus excellent printability can be obtained.

When the rosin and the animal and vegetable oil fatty acid in the present invention is modified with an α,β-ethylenically unsaturated dibasic acid, drying properties of the printing ink can be more improved.

When the rosin modified phenolic resin of the present invention is modified with a petroleum resin, hydrophobicity of the printing ink is improved and emulsifiability resistance is also improved.

According to the gel varnish of the present invention, it is made possible to use no volatile organic solvent, which has conventionally been used as the solvent, or to reduce the amount of the volatile organic solvent.

Furthermore, the printing ink of the present invention is environmentally friendly because it contains no or a reduced amount of a volatile organic solvent, and can be used as a sheet-fed ink and a web offset ink in the offset printing. Also in case of printing on coat papers and art papers, excellent drying properties, gloss, emulsifiability resistance and misting resistance can be achieved as compared with the aforementioned conventional non-VOC or VOC-less printing ink. When using as a sheet-fed ink, flow properties and gloss are improved and setting time decreases, and also stacking stability is improved. When using as a web offset ink and a news ink, the ink is suited for high speed printing because of its quick drying property, and also shows less misting, less variation in physical properties with a lapse of time and high operation efficiency. When using as a waterless ink, a cohesive force of the ink is obtained and ground contamination can be prevented.

The present invention will be described in detail by way of the Examples and Comparative Examples, however, the present invention is not limited to the following

### EXAMPLES

### Example 1

<Production of Phenol Formaldehyde Initial Condensate>

In a reaction vessel, 550 parts by weight of para-tertiary butylphenol, 183 parts by weight of bisphenol A, 290 parts by weight of 92% paraformaldehyde and 100 parts by weight of xylene were charged and 15 parts by weight of sodium hydroxide was added, and then the mixture was heated to 90° C. and maintained at the same temperature for 5 hours to obtain a resol type phenol formaldehyde initial condensate (solid content: 87.9%).

<Production of Rosin Modified Phenolic Resin>

In a reaction vessel, 500 parts by weight of a tall oil rosin “HARTALL rosin WW” manufactured by Harima Chemicals, Inc., 100 parts by weight of soybean oil fatty acid, 110 parts by weight of n-butanol and 0.5 parts by weight of paratoluenesulfonic acid as the catalyst were charged, and then the mixture was esterified under reflux of n-butanol while heating to 150° C. over 4 hours. At the time when the acid value of the contents reached 70 to 80, 28 parts by weight of pentaerythritol was added and esterification was conducted by heating to 270° C. until the acid value reached 20. 170 Parts by weight of the phenol formaldehyde initial condensate was added dropwise at 250° C. over 3 hours and, after aging for 2 hours, the resulting rosin modified phenolic resin was taken out.

### Example 2

In a reaction vessel, 500 parts by weight of “HARTALL rosin WW”, 100 parts by weight of soybean oil fatty acid, 110 parts by weight of n-butanol and 0.5 parts by weight of paratoluenesulfonic acid as the catalyst were charged, and then the mixture was esterified under reflux of n-butanol while heating to 150° C. over 4 hours until the acid value reached 70 to 80. The same phenol formaldehyde initial condensate as in Example 1 was added in the same amount as in Example 1 and, after heating slowly, 28 parts by weight of pentaerythritol was added at 220° C. After the mixture was heated to 270° C. over 6 hours and aged at 270° C. for 8 hours, the resulting rosin modified phenolic resin was taken out.

### Example 3

In the same manner as in Example 1, except that, before adding pentaerythritol after esterifying under reflux of n-butanol, 18 parts by weight of maleic anhydride was added and maleination was conducted at 200° C. for one hour, a rosin modified phenolic resin was obtained.

### Example 4

In the same manner as in Example 1, except that the amount of n-butanol was changed to 200 parts by weight, the acid value of the contents was changed to 40 to 50 in the esterification with n-butanol, and the amount of pentaerythritol was changed to 18 parts by weight, a rosin modified phenolic resin was obtained.

### Example 5

In the same manner as in Example 1, except that the amount of n-butanol was changed to 35 parts by weight, the acid value of the contents was changed to 160 to 170 in the esterification with n-butanol, and 53 parts by weight of glycerin was used in place of pentaerythritol, a rosin modified phenolic resin was obtained.

### Example 6

In the same manner as in Example 1, except that the amount of “HARTALL rosin WW” was changed to 400 parts by weight and 200 parts by weight of “HARTALL R-50” manufactured by Harima Chemicals, Inc. (mixture containing 50% by weight of a rosin component and 50% by weight of a tall oil fatty acid component) was used in place of soybean oil fatty acid, a rosin modified phenolic resin was obtained.

### Example 7

In the same manner as in Example 1, except that 600 parts by weight of “HARTALL R-50” was charged in place of “HARTALL rosin WW” and soybean oil fatty acid, a rosin modified phenolic resin was obtained.

### Example 8

In the same manner as in Example 1, except that the amount of “HARTALL rosin WW” was changed to 400 parts by weight, 200 parts by weight of “HARTALL R-30” manufactured by Harima Chemicals, Inc. (mixture containing 30% by weight of a rosin component and 70% by weight of a tall oil fatty acid component) was charged in place of soybean oil fatty acid, and 190 parts by weight of 2-ethylhexyl alcohol was charged in place of n-butanol, a rosin modified phenolic resin was obtained.

### Example 9

In the same manner as in Example 1, except that no paratoluenesulfonic acid was added in the production of the rosin modified phenolic resin, a rosin modified phenolic resin was obtained.

### Example 10

In the same manner as in Example 1, except that, before adding dropwise the phenol formaldehyde initial condensate after esterifying with pentaerythritol, 60 parts by weight of petroleum resin “MARUKAREZ S-115A” manufactured by Maruzen Petrochemical Co., Ltd. was added, a rosin modified phenolic resin was obtained.

### Example 11

In the same manner as in Example 2, except that, before adding the phenol formaldehyde initial condensate, 60 parts by weight of “MARUKAREZ S-115A” was added, a rosin modified phenolic resin was obtained.

### Comparative Example 1

As the rosin modified phenolic resin, “HARIPHENOL ERP-40” (weight average molecular weight: 200,000) manufactured by Harima Chemicals, Inc. was used. “HARIPHENOL ERP-40” is obtained by reacting a rosin, a phenol formaldehyde initial condensate and glycerin.

### Comparative Example 2

As the rosin modified phenolic resin, “HARIPHENOL P-637” (weight average molecular weight: 100,000) manufactured by Harima Chemicals, Inc. was used. “HARIPHENOL P-637” is obtained by reacting a rosin, a phenol formaldehyde initial condensate and pentaerythritol.

### Comparative Example 3

In the same manner as in Example 1, except that the amount of n-butanol was changed to 250 parts by weight, the acid value of the contents was changed to less than 30 in the esterification with n-butanol, the amount of pentaerythritol was changed to 10 parts by weight, and the acid value was changed to 15 in the esterification with pentaerythritol, a rosin modified phenolic resin was obtained.

### Comparative Example 4

A trial of producing the rosin modified phenolic resin was made in the same manner as in Example 1, except that the amount of n-butanol was changed to 20 parts by weight, the acid value of the contents was changed to 175 to 180 in the esterification with n-butanol, and 65 parts by weight of glycerin was added in place of pentaerythritol. However, it became impossible to stir the mixture because the molecular weight of the resin increased excessively during the dropwise addition of the phenol formaldehyde initial condensate, and thus the reaction was terminated.

The composition of the rosin modified phenolic resin as well as the evaluation results of softening point, acid value, viscosity (linseed oil viscosity), solubility in solvent (Solvent AF6 dissolution cloud point) and weight average molecular weight of the resin in Examples 1 to 11 and Comparative Examples 1 to 4 are shown in Table 1. The viscosity and solubility were evaluated by the following procedures.

Linseed oil viscosity (Gardner bubble type viscosity): A mixture was obtained by mixing linseed oil and a rosin modified phenolic resin in a weight ratio of 2:1 and dissolving with heating and the time that is required for bubbles to reach a standard line was measured by a Gardner bubble type viscometer manufactured by BYK Gardner Co.

Solubility in solvent (Solvent AF6 dissolution cloud point): The cloud point temperature of a solution (resin/solvent AF6=1/10) was measured by a Chemotronic cloud point meter manufactured by Novocontrol Co.

Weight average molecular weight: The molecular weight relative to polystyrene standards was measured by gel permeation chromatography (GPC).

TABLE 1
unit: parts by weight

| | Example 1 | Example 2 | Example 3 | Example 4 | Example 5 | Example 6 | Example 7 | Example 8 |
|---|---|---|---|---|---|---|---|---|
| HARTALL rosin WW | 500 | 500 | 500 | 500 | 500 | 400 | | 400 |
| Soybean oil fatty acid | 100 | 100 | 100 | 100 | 100 | | | |
| HARTALL R-50 | | | | | | 200 | 600 | |
| HARTALL R-30 | | | | | | | | 200 |
| Maleic anhydride | | | 18 | | | | | |
| n-butanol | 110 | 110 | 110 | 200 | 35 | 110 | 110 | |
| 2-ethylhexyl alcohol | | | | | | | | 190 |
| Pentaerythritol | 28 | 28 | 28 | 18 | | 28 | 28 | 28 |
| Glycerin | | | | | 53 | | | |
| Phenol formaldehyde | 170 | 170 | 170 | 170 | 170 | 170 | 170 | 170 |
| initial condensate | | | | | | | | |
| (solid content: 87.9%) | | | | | | | | |
| Softening point (° C.) | 149 | 153 | 158 | 125 | 162 | 143 | 123 | 137 |
| Acid value | 22.3 | 23.2 | 20.8 | 22.1 | 18.6 | 21.2 | 17.4 | 17.6 |
| (mgKOH/g) | | | | | | | | |
| Linseed oil viscosity | 96 | 125 | 154 | 53 | 260 | 78 | 37 | 60 |
| (sec.) | | | | | | | | |
| Solubility in solvent | 175 | 200< | 200< | 132 | 200< | 108 | 105 | 87 |
| (° C.) | | | | | | | | |
| Weight average | 120000 | 80000 | 160000 | 5000 | 300000 | 100000 | 80000 | 30000 |
| molecular weight | | | | | | | | |

| | | | | Comparative | Comparative | Comparative | Comparative |
|---|---|---|---|---|---|---|---|
| | Example 9 | Example 10 | Example 11 | Example 1 | Example 2 | Example 3 | Example 4 |
| HARTALL rosin WW | 500 | 500 | 500 | | | 500 | 500 |
| Soybean oil fatty acid | 100 | 100 | 100 | | | 100 | 100 |
| n-butanol | 110 | 110 | 110 | | | 250 | 20 |
| Petroleum resin | | 60 | 60 | | | | |
| Pentaerythritol | 28 | 28 | 28 | | | 10 | |
| Glycerin | | | | | | | 65 |
| Phenol formaldehyde | 170 | 170 | 170 | | | 170 | |
| initial condensate | | | | | | | |
| (solid content: 87.9%) | | | | | | | |
| Softening point (° C.) | 145 | 151 | 154 | 160 | 168 | 98 | |
| Acid value | 24.2 | 18.2 | 16.8 | 18 | 23 | 18.2 | |
| (mgKOH/g) | | | | | | | |
| Linseed oil viscosity | 87 | 80 | 84 | 450 | 300 | 34 | |
| (sec.) | | | | | | | |
| Solubility in solvent | 156 | 124 | 140 | 70 | 30> | 64 | |
| (° C.) | | | | | | | |
| Weight average | 90000 | 40000 | 60000 | 200000 | 100000 | 2000> | gelation |
| molecular weight | | | | | | | |

<Production of Gel Varnish>

Each of the rosin modified phenolic resins obtained in Examples 1 to 11 and Comparative Examples 1 to 3, soybean oil, and a soybean oil fatty acid isobutyl ester “SE-120-IB” manufactured by Nikka Chemieal Co., Ltd. were charged in a reaction vessel in each amount shown in Table 2, heated while blowing a nitrogen gas into the reaction vessel, and then maintained at 200° C. while stirring for 30 minutes to obtain a varnish. The resulting varnish was cooled to 100° C. and a gelling agent was added in the amount shown in Table 2 so as to achieve proper viscosity suited for printing ink, and then the mixture was heated again to 200° C. and maintained for one hour to obtain a gel varnish for printing ink. As the gelling agent, those obtained by diluting 70 parts of “Chelope EP-12” manufactured by Hope Chemical Co., Ltd. with 30 parts of a soybean oil fatty acid isobutyl ester “SE-120-IB” were used.

Since the rosin modified phenolic resin obtained in Comparative Example 3 had a low molecular weight such as 2,000 or lower, a gel varnish required for production of a sheet-fed ink could not be obtained and, therefore, the printing ink could not be evaluated.

TABLE 2
unit: parts by weight

| | Example 1 | Example 2 | Example 3 | Example 4 | Example 5 | Example 6 | Example 7 | Example 8 |
|---|---|---|---|---|---|---|---|---|
| Rosin modified | 45.0 | 43.0 | 41.0 | 60.0 | 40.0 | 46.0 | 68.0 | 60.0 |
| phenolic resin | | | | | | | | |
| Soybean oil | 20.0 | 20.0 | 20.0 | 20.0 | 20.0 | 20.0 | 20.0 | 20.0 |
| Soybean oil fatty acid | 35.0 | 37.0 | 39.0 | 20.0 | 40.0 | 34.0 | 12.0 | 20.0 |
| isobutyl ester | | | | | | | | |
| Gelling agent | 0.9 | 1.0 | 0.8 | 3.0 | 0.5 | 1.0 | 1.0 | 1.6 |
| Total | 100.9 | 101.0 | 100.8 | 103.0 | 100.5 | 101.0 | 101.0 | 101.6 |

| | | | | Comparative | Comparative | Comparative |
|---|---|---|---|---|---|---|
| | Example 9 | Example 10 | Example 11 | Example 1 | Example 2 | Example 3 |
| Rosin modified | 45.0 | 47.0 | 45.0 | 40.0 | 40.0 | 68.0 |
| phenolic resin | | | | | | |
| Soybean oil | 20.0 | 20.0 | 20.0 | 20.0 | 20.0 | 20.0 |
| Soybean oil fatty acid | 35.0 | 33.0 | 35.0 | 40.0 | | 12.0 |
| isobutyl ester | | | | | | |
| Solvent AF6 | | | | | 40.0 | |
| Gelling agent | 1.0 | 1.3 | 1.1 | 0.5 | 1.0 | 3.0 |
| Total | 101.0 | 101.3 | 101.1 | 100.5 | 101.0 | 103.0 |

<Production of Printing Ink>

In the varnish, 18 parts of Cyanine Blue (manufactured by DAINIPPON INK & CHEMICALS Co., Ltd.) as the indigo blue pigment shown in Table 3 was dispersed by a three-roll mill and the gel varnish and a soybean oil fatty acid isobutyl ester “SE-120-IB” were added so as to adjust tack to 9 to 10. Then, “Solvent AF6” was optionally added in the amount shown in Table 3 and the mixture was uniformly mixed with 0.5 parts by weight of a 6% manganese naphthenate solution (Harima Chemicals, Inc.) to obtain a printing ink. Physical properties of the resulting printing ink are shown in Table 4.

Physical properties of the printing ink shown in Table 4 were evaluated by the following procedures.

Flow properties (flow: 60 second, mm): Using Spread Meter manufactured by RIGO CO., Ltd., spread (diameter) of the ink (60 seconds) was measured.

Gloss value: 0.3 cc of the ink was spread over an art paper by an entire surface roll of RI Tester manufactured by Akira Seisakusho and, after 24 hours, the gloss value was measured by a 60°-60° gloss meter.

Set: 0.1 cc of the ink was spread by 4-Cut Roll of RI Tester manufactured by Akira Seisakusho and a spread matter was cut and then laminated on another art paper to obtain a sample. The roll of RI Tester was used to measure the time (minutes) required until ink is not deposited on the art paper.

Drying properties on machine: 0.1 cc of the ink was spread over a parchment paper by 4-Cut Roll of RI Tester manufactured by Akira Seisakusho and, after laminating the parchment papers, the resulting sample was mounted to a Choyokai type drying tester and the drying time was compared under the conditions of 0.1 rpm.

Maximum emulsification amount: Using Lithotronic Emulsification Tester manufactured by Novocontrol Co., water was added to 25 g of the ink at 40° C. at a rate of 2 ml/mn. and the moisture content upon saturation of the ink was measured (rotation number of Emulsification Tester: 1200 rpm).

Misting: Two cups of the ink on Inkometer manufactured by Toyo Seiki Seisaku-Sho, Ltd. and rotated at a roll temperature of 40° C. and 2000 rpm for 2 minutes. Then, the state of the ink scattered on a white paper placed under or front of the roll was visually observed. The following five-rating evaluation was conducted.

5: no misting

4: slight misting

3: some misting

2: considerable misting

1: severe misting

TABLE 3
unit: parts by weight

| | Example 1 | Example 2 | Example 3 | Example 4 | Example 5 | Example 6 | Example 7 | Example 8 |
|---|---|---|---|---|---|---|---|---|
| Gel varnish | 78.0 | 77.0 | 76.0 | 82.0 | 75.0 | 78.0 | 78.0 | 82.0 |
| Indigo blue pigment | 18.0 | 18.0 | 18.0 | 18.0 | 18.0 | 18.0 | 18.0 | 18.0 |
| Soybean oil fatty acid | 4.0 | 4.0 | 4.0 | | 4.0 | 3.0 | 4.0 | |
| isobutyl ester | | | | | | | | |
| Solvent AF6 | | 1.0 | 2.0 | | 3.0 | 1.0 | | |
| Manganese | 0.5 | 0.5 | 0.5 | 0.5 | 0.5 | 0.5 | 0.5 | 0.5 |
| naphthenate solution | | | | | | | | |
| Total | 100.5 | 100.5 | 100.5 | 100.5 | 100.5 | 100.5 | 100.5 | 100.5 |

| | | | | Comparative | Comparative | Comparative |
|---|---|---|---|---|---|---|
| | Example 9 | Example 10 | Example 11 | Example 1 | Example 2 | Example 3 |
| Gel varnish | 78.0 | 78.0 | 78.0 | 70.0 | 70.0 | Since the |
| Indigo blue pigment | 18.0 | 18.0 | 18.0 | 18.0 | 18.0 | viscosity |
| Soybean oil fatty acid | 4.0 | 4.0 | 4.0 | 9.0 | | was low, an |
| isobutyl ester | | | | | | ink could |
| Solvent AF6 | | | | 3.0 | 12.0 | not be |
| Manganese | 0.5 | 0.5 | 0.5 | 0.5 | 0.5 | obtained. |
| naphthenate solution | | | | | | |
| Total | 100.5 | 100.5 | 100.5 | 100.5 | 100.5 | |

TABLE 4

| | Example 1 | Example 2 | Example 3 | Example 4 | Example 5 | Example 6 | Example 7 |
|---|---|---|---|---|---|---|---|
| Tack (400 rpm, 30° C.) | 9.3 | 9.1 | 9.0 | 10.0 | 8.8 | 9.2 | 9.0 |
| Flow property | 32.0 | 31.8 | 31.6 | 33.0 | 31.6 | 32.0 | 33.0 |
| (60 sec., mm) | | | | | | | |
| Gloss value | 70.0 | 67.5 | 68.5 | 82.0 | 69.5 | 70.5 | 73.0 |
| Set (min.) | 21 | 21 | 21 | 30 | 18 | 24 | 24 |
| Drying property on | 15< | 15< | 15< | 15< | 15< | 15< | 15< |
| machine (hr) | | | | | | | |
| Maximum | 55 | 75 | 65 | 75 | 65 | 60 | 55 |
| emulsification amount | | | | | | | |
| (%) | | | | | | | |
| Misting | 4 | 5 | 5 | 3 | 5 | 4 | 4 |

| | | | | | Comparative | Comparative |
|---|---|---|---|---|---|---|
| | Example 8 | Example 9 | Example 10 | Example 11 | Example 1 | Example 2 |
| Tack (400 rpm, 30° C.) | 9.4 | 9.4 | 9.2 | 9.2 | 9.1 | 9.4 |
| Flow property | 33.2 | 32.0 | 33.6 | 32.8 | 30.2 | 31.4 |
| (60 sec., mm) | | | | | | |
| Gloss value | 78.0 | 67.0 | 73.0 | 70.5 | 67.0 | 66.0 |
| Set (min.) | 24 | 21 | 27 | 24 | 30 | 18 |
| Drying property on | 15< | 15< | 15< | 15< | 15< | 14 |
| machine (hr) | | | | | | |
| Maximum | 75 | 55 | 50 | 50 | 90 | 65 |
| emulsification amount | | | | | | |
| (%) | | | | | | |
| Misting | 3 | 5 | 3 | 4 | 2 | 5 |

<Evaluation Results>

As is apparent from the evaluation results of physical properties of the respective inks shown in Table 4, the sheet-fed inks obtained from the rosin modified phenolic resin of Examples 1 to 11 showed excellent set (drying properties) and high gloss as compared with the sheet-fed ink (Comparative Example 1) obtained by using a conventional rosin modified phenolic resin and replacing a volatile organic solvent by a fatty acid monoester originating from an animal and vegetable oil when formed into a gel varnish. The inks of Examples 1 to 11 were excellent in emulsifiability resistance because the maximum emulsification amount decreased as compared with Comparative Example 1, and also showed improved misting resistance.

Furthermore, the sheet-fed inks obtained from the rosin modified phenolic resins of Examples 1 to 11 showed excellent or equivalent gloss, set, emulsifiability resistance and misting resistance in printing on an art paper as compared with the sheet-fed ink (Comparative Example 2) obtained by adding a conventionally used ink solvent made of a volatile organic solvent. Thus, it could been confirmed that the non-VOC or VOC-less offset printing ink containing the rosin modified phenolic resin of the present invention sufficiently meet the demand of the market to a conventional printing ink.

What is clamed is:

1. A rosin modified phenolic resin having a weight average molecular weight of 3,000 to 400,000, which is obtained by reacting a monoester with a polyhydric alcohol and a phenol formaldehyde initial condensate, said monoester being prepared by partially esterifying a rosin and an animal and vegetable oil fatty acid with a monoalcohol.

2. The rosin modified phenolic resin according to claim 1, wherein the monoalcohol is a compound having 1 to 8 carbon atoms.

3. The rosin modified phenolic resin according to claim 1, wherein tall oil is used as a mixture of the rosin and the animal and vegetable oil fatty acid.

4. The rosin modified phenolic resin according to claim 1, wherein the amount of the animal and vegetable oil fatty acid is from 2 to 300 parts by weight based on 100 parts by weight of the rosin.

5. The rosin modified phenolic resin according to claim 1, wherein the monoester has an acid value of 30 to 170.

6. The rosin modified phenolic resin according to claim 1, wherein the rosin and the animal and vegetable oil fatty acid are modified with an α,β-ethylenically unsaturated dibasic acid.

7. The rosin modified phenolic resin according to claim 1, which is modified with a petroleum resin.

8. A gel varnish comprising the rosin modified phenolic resin of claim 1, an animal and vegetable oil component, and a gelling agent.

9. The gel varnish according to claim 8, wherein a portion or all of the animal and vegetable oil component is a fatty acid monoester.

10. The gel varnish according to claim 8, which contains 35 to 70% by weight of the rosin modified phenolic resin.

11. A printing ink comprising the gel varnish of claim 8.

12. The printing ink according to claim 11, which contains 60 to 90% by weight of the gel varnish.

13. A printing method, which comprising printing using the printing ink of claim 11.

14. The printing method according to claim 13, which is a offset printing method.

15. A method for producing a rosin modified phenolic resin having a weight average molecular weight of 3,000 to 400,000, which comprises esterifying a rosin and an animal and vegetable oil fatty acid with a monoalcohol, esterifying the product with a polyhydric alcohol, and reacting the product with a phenol formaldehyde initial condensate.

16. The method according to claim 15, wherein the monoalcohol is a compound having 1 to 8 carbon atoms.

17. The method according to claim 15, wherein an acid catalyst is used as a catalyst for esterification with the monoalcohol.

18. The method according to claim 15, wherein the rosin and the animal and vegetable oil fatty acid are modified with an α,β-ethylenically unsaturated dibasic acid before esterifying with the monoalcohol.

19. The method according to claim 15, wherein the product obtained by esterifying with the polyhydric alcohol is modified with a petroleum resin before reacting with the phenol formaldehyde initial condensate.

20. A method for producing a rosin modified phenolic resin having a weight average molecular weight of 3,000 to 400,000, which comprises esterifying a rosin and an animal and vegetable oil fatty acid with a monoalcohol, reacting the product with a phenol formaldehyde initial condensate, and esterifying the product with a polyhydric alcohol.

21. The method according to claim 20, wherein the monoalcohol is a compound having 1 to 8 carbon atoms.

22. The method according to claim 20, wherein an acid catalyst is used as a catalyst for esterification with the monoalcohol.

23. The method according to claim 20, wherein the rosin and the animal and vegetable oil fatty acid are modified with an α,β-ethylenically unsaturated dibasic acid before esterifying with the monoalcohol.

24. The method according to claim 20, wherein the product obtained by esterifying with the monoalcohol is modified with a petroleum resin before reacting with the phenol formaldehyde initial condensate.
